(19) United States
(12) Patent Application Publication
(10) Pub. No.: US 2023/0359199 A1
(43) Pub. Date: Nov. 9, 2023

(54) AUGMENTED REALITY VESSEL MANEUVERING SYSTEM AND METHOD

(71) Applicant: Furuno Electric Co., Ltd., Nishinomiya (JP)

(72) Inventors: Satoshi ADACHI, Osaka (JP); Eisuke SEKINE, Easton, MD (US); Katsuhiro SUZUKI, Kobe (JP); Koji ATSUMI, Takarazuka (JP); Daisuke Matsumoto, Kobe (JP)

(21) Appl. No.: 18/351,330

(22) Filed: Jul. 12, 2023

Related U.S. Application Data
(63) Continuation-in-part of application No. PCT/JP2021/046709, filed on Dec. 17, 2021.

(30) Foreign Application Priority Data
Jan. 18, 2021 (JP) 2021-005741

(51) Int. Cl. G05D 1/00; G05D 1/08

(52) U.S. Cl. CPC G05D 1/0038; G05D 1/0044; G05D 1/0875

(57) ABSTRACT

Various embodiments of the present disclosure provide an augmented reality (AR) vessel maneuvering system and method capable of intuitively and easily setting at least one of: a target position and an attitude of a vessel. The AR vessel maneuvering system includes processing circuitry configured to generate an image including a vessel object representing a vessel in a region corresponding to a viewpoint position and a line-of-sight direction, superimpose and display the image including the vessel object on an outside scene of the region corresponding to the viewpoint position and the line-of-sight direction, detect an operation on the vessel object displayed in the image, and output a command to a navigation device used for navigating the vessel to execute a navigation operation corresponding to the operation on the vessel object. The navigation device is a marine navigation device.

### CROSS-REFERENCE TO RELATED APPLICATION(S)

This application is a continuation-in-part of PCT International Application No. PCT/JP2021/046709, which was filed on Dec. 17, 2021, and which claims priority to Japanese Patent Application No. 2021-005741 filed on Jan. 18, 2021, the entire disclosures of each of which are herein incorporated by reference for all purposes.

### TECHNICAL FIELD

The present disclosure relates to an augmented reality (AR) vessel maneuvering system and an AR vessel maneuvering method.

### BACKGROUND

A marine environment display device is disclosed that receives a position of an object on the ocean and displays an object indicator as an augmented reality (AR) image on an image captured by a camera.
Patent Document 1: U.S. Patent Application Publication No. 2015/0350552.
Patent Document 2: Japanese Unexamined Patent Application Publication No. Hei06-301897.

### SUMMARY

It is convenient to provide a new vessel maneuvering method of the vessel to more intuitively and easily set the target position or attitude of a vessel.

The present disclosure provides an augmented reality (AR) vessel maneuvering system and an AR vessel maneuvering method capable of more intuitively and easily setting at least one of: a target position and an attitude of a vessel.

According to an aspect of the present disclosure, an AR vessel maneuvering system includes processing circuitry configured to: generate an image including a vessel object representing a vessel in a region corresponding to a viewpoint position and a line-of-sight direction, superimpose and display the image including the vessel object on an outside scene of the region corresponding to the viewpoint position and the line-of-sight direction, detect an operation on the displayed vessel object.

In the above aspect, the processing circuitry is further configured to output a command to a navigation device used for navigating the vessel to execute a navigation operation corresponding to the operation on the vessel object.

In the above aspect, the processing circuitry is further configured to determine a target value for the navigation device based on at least one of: a position and an attitude of the vessel object after the operation.

In the above aspect, the navigation device is a marine navigation device.

In the above aspect, the navigation device is an automatic steering device implemented on the vessel, and the target value is one of a target heading and a target steering angle associated with the automatic steering device.

In the above aspect, the navigation device is an engine control device implemented on the vessel, and the target value is one of a target output power and a target speed for the engine control device.

In the above aspect, the navigation device is a plotter implemented on the vessel, and the target value is one of a target route and a waypoint for the plotter.

In the above aspect, the processing circuitry is further configured to set movable range of the vessel object based on at least one of: characteristics of the vessel object and navigation region information of the vessel object.

In the above aspect, the processing system is further configured to: acquire information associated with navigation of the vessel, determine a predicted position of the vessel after a predetermined time has elapsed based on the information associated with the navigation of the vessel, and generate an image including a vessel object representing the vessel at a position corresponding to the predicted position.

In the above aspect, the information associated with the navigation of the vessel is information indicating at least one of: a vessel speed, a steering angle, and a heading of the vessel.

In the above aspect, the information associated with the navigation of the vessel is at least one of: a target route and a waypoint of the vessel.

In the above aspect, the image is displayed on a head-mounted display, and the processing circuitry is further configured to set a viewpoint position and a line-of-sight direction according to a position and an attitude of the head-mounted display, and generate an image including the vessel object by rendering the vessel object arranged at a position corresponding to a virtual three-dimensional space.

An AR vessel maneuvering method according to another aspect of the present disclosure includes: generating an image including a vessel object representing a vessel in a region corresponding to a viewpoint position and a line-of-sight direction, superimposing and displaying the image including the vessel object on an outside scene of the region corresponding to the viewpoint position and the line-of-sight direction, detecting an operation on the vessel object displayed in the image.

A non-transitory computer-readable storage medium having stored thereon machine-readable instructions that, when executed by one or more processors of an apparatus, cause the apparatus to perform a method according to another aspect of the present disclosure includes: generating an image including a vessel object representing a vessel in a region corresponding to a viewpoint position and a line-of-sight direction, superimposing and displaying the image including the vessel object on an outside scene of the region corresponding to the viewpoint position and the line-of-sight direction, detecting an operation on the vessel object displayed in the image.

According to the present disclosure, it is possible to provide a new vessel maneuvering method for a vessel, and it is possible to more intuitively and easily set a target position or an attitude.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a block diagram illustrating an exemplary configuration of an augmented reality (AR) vessel maneuvering system, in accordance with an embodiment of the present disclosure;

FIG. 2 is a diagram illustrating an exemplary external appearance of a head-mounted display, in accordance with an embodiment of the present disclosure;

FIG. 3 is a block diagram illustrating an exemplary configuration of the head-mounted display of FIG. 2, in accordance with an embodiment of the present disclosure;

FIG. 4 is a block diagram illustrating an exemplary configuration of an image generator, in accordance with an embodiment of the present disclosure;

FIG. 5 is a flow chart illustrating an exemplary procedure of an AR vessel maneuvering method, in accordance with an embodiment of the present disclosure;

FIG. 6 is a flow diagram following FIG. 5, in accordance with an embodiment of the present disclosure;

FIG. 7 is a diagram illustrating an example of a virtual three-dimensional space, in accordance with an embodiment of the present disclosure;

FIG. 8 is a diagram illustrating an example of an image displayed on a head-mounted display, in accordance with an embodiment of the present disclosure;

FIG. 9 is a diagram illustrating an example of an operation on a vessel object, in accordance with an embodiment of the present disclosure;

FIG. 10 is a diagram illustrating an example of an operation on a vessel object, in accordance with an embodiment of the present disclosure; and

FIG. 11 is a diagram illustrating an example of a movable range, in accordance with an embodiment of the present disclosure.

### DETAILED DESCRIPTION OF THE EMBODIMENTS

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

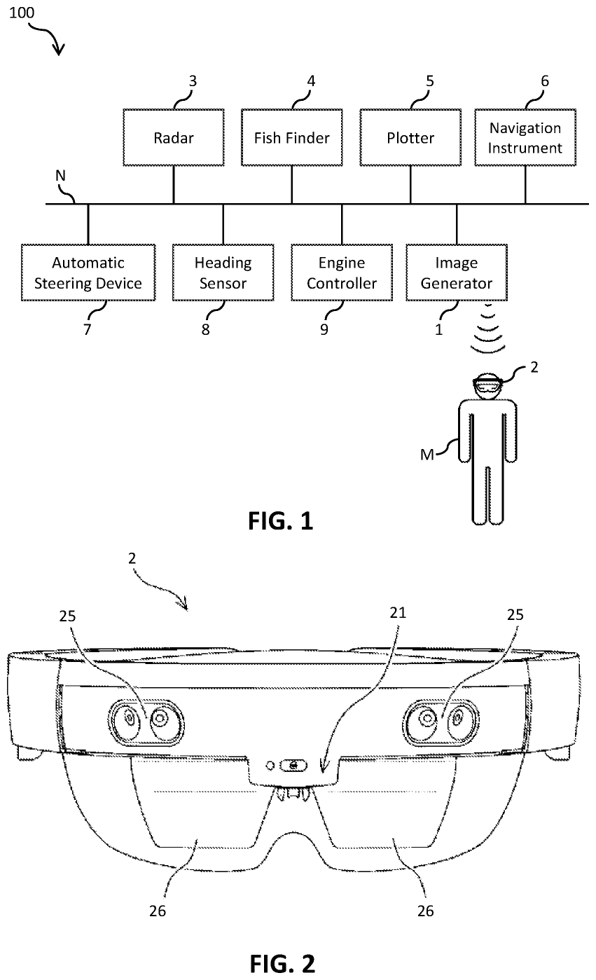

FIG. 1 is a block diagram illustrating an exemplary configuration example of an augmented reality (AR) vessel maneuvering system 100, in accordance with an embodiment of the present disclosure. The AR vessel maneuvering system 100 is implemented on, for example, a vessel. A marine vessel is an example of the vessel. The vessel may also be an aircraft, a vehicle, an automobile, a moving object, a rocket, a space craft, or the like.

The AR vessel maneuvering system 100 includes an image generator 1, a radar 3, a fish finder 4, a plotter 5, a navigational instrument 6, an automatic steering device 7, a heading sensor 8, an engine controller 9, and the like. The aforementioned components are connected to a network N such as a controller area network (CAN), a local area network (LAN), and/or a National Marine Electronics Association (NMEA) [0183/2000], and may perform network communication with each other.

The AR vessel maneuvering system 100 further includes a head-mounted display 2 (hereinafter, it is referred to as an HMD 2.) worn on the head of a user M. The HMD 2 is an example of a display, and wirelessly communicates with the image generator 1 to display an image received from the image generator 1.

The radar 3 emits microwaves by an antenna, receives reflected waves of the microwaves, and generates radar information based on a reception signal. The radar information includes a distance and a direction of a target present around the vessel.

The fish finder 4 transmits ultrasonic waves into the water by an ultrasonic transducer installed on the bottom of the vessel, receives the reflected waves, and generates underwater detection information based on the received signals. The underwater detection information includes information on a school of fish and the sea bottom in the water.

The plotter 5 plots a current location of the vessel calculated based on radio waves received from a global navigation satellite system (GNSS) on a chart (e.g., a nautical chart).

In one embodiment, the plotter 5 functions as a navigation device and generates a target route to a destination. The target route may include one or more waypoints. The plotter 5 transmits a target heading based on the target route to the automatic steering device 7.

The navigation instrument 6 is, for example, an instrument used for navigation, such as a speedometer or a tidal current meter. The heading sensor 8 is also a type of navigational instrument 6. The heading sensor 8 determines a heading of the vessel.

The automatic steering device 7 determines a target steering angle based on the heading information acquired from the heading sensor 8 and the target heading acquired from the plotter 5, and drives the steering device so that a steering angle of the automatic steering device 7 approaches the target steering angle. The heading sensor 8 is a GNSS/GPS compass, a magnetic compass, or the like.

The engine controller 9 controls an electronic throttle, a fuel injection device, an ignition device, and the like of an engine of the vessel based on an amount of an accelerator operation.

The plotter 5, the navigation instrument 6, the automatic steering device 7, and the heading sensor 8 are examples of an acquisitor that acquires information related to navigation of a vessel. The information related to the navigation of the vessel may be information indicating the navigation state of the vessel or may be navigation information of the vessel.

The information indicating the navigation state of the vessel includes, for example, a vessel speed acquired by a speedometer of the navigation instrument 9, a tidal current acquired by a tidal current meter, a steering angle acquired by the automatic steering device 7, the heading acquired by the heading sensor 8, and the like.

The navigation information of the vessel includes, for example, a target route and a waypoint acquired by the plotter 5.

The plotter 5, the automatic steering device 7, and the engine controller 9 are examples of a marine navigation device used for navigating a vessel.

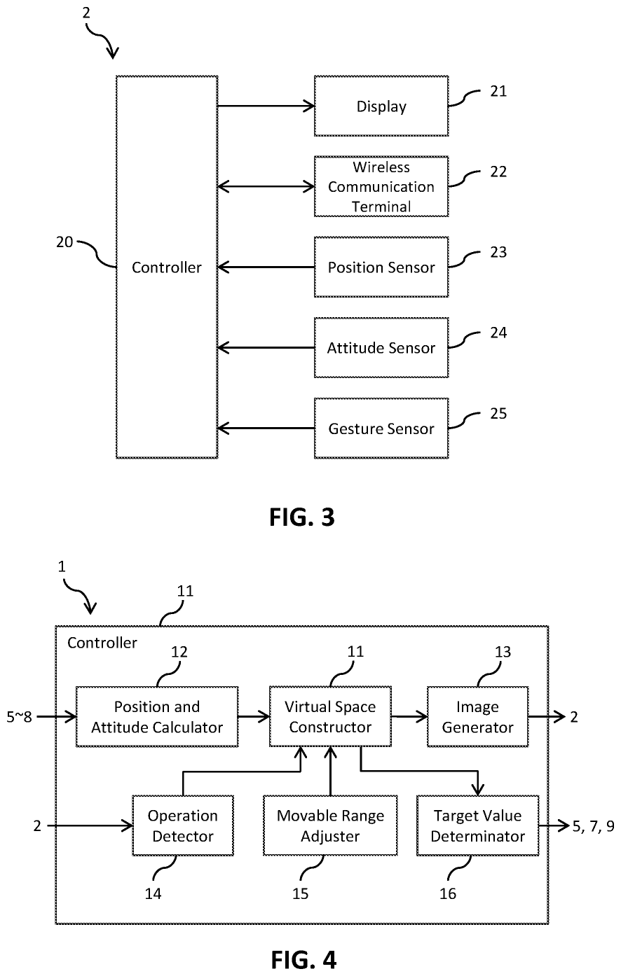

FIG. 2 is a diagram illustrating an exemplary external appearance of the HMD 2, in accordance with an embodiment of the present disclosure. FIG. 3 is a block diagram illustrating an exemplary configuration of the HMD 2, in accordance with an embodiment of the present disclosure. The HMD 2 is a transmissive head-mounted display, and performs AR/Mixed Reality (MR) by superimposing an image on an outside scene visually recognized by a user.

As illustrated in FIG. 2, the HMD 2 includes a display 21 that projects an image onto a half minor 26 disposed in front of the eyes of the user M. The light of the outside scene transmitted through the half mirror 26 and the light of the image projected on the half minor 26 are superimposed and incident on the eyes of the user M. By providing a parallax between the image seen by the left eye and the image seen by the right eye, the user M may three-dimensionally recognize the image.

As illustrated in FIG. 3, the HMD 2 includes a controller 20, a display 21, a wireless communication terminal 22, a position sensor 23, an attitude sensor 24, and a gesture sensor 25.

The controller 20 is a computer including a central processing unit (CPU), a random access memory (RAM), a read only memory (ROM), a nonvolatile memory, an input/output interface, and the like. The controller 20 may include a graphics processing unit (GPU) for executing three-dimensional (3D) image processing at high speed. In the controller 20, the CPU executes information processing in accordance with a program loaded from the ROM or the nonvolatile memory to the RAM. The controller 20 may be realized by an arithmetic processing unit or processing circuitry such as a personal computer or a dedicated electronic circuit.

The wireless communication terminal 22 provides wireless communication with the external image generator 1 or the like. The wireless communication is performed by, for example, a wireless LAN, Bluetooth (registered trademark), or the like. In an alternate embodiment, the controller 20 may perform wired communication with the external image generator 1 or the like.

The position sensor 23 detects a position of the HMD 2 and provides position information to the controller 20. The position sensor 23 is, for example, a GNSS receiver. The controller 20 may acquire the position information from the plotter 5 (see FIG. 1) or the like.

The attitude sensor 24 detects an attitude such as a direction and an inclination of the HMD 2 and provides attitude information to the controller 20. The attitude sensor 24 is, for example, a gyro sensor. In particular, an inertial measurement unit including a three-axis acceleration sensor and a three-axis gyro sensor is preferable.

The gesture sensor 25 detects a gesture of the user M and provides gesture information to the controller 20. The gesture sensor 25 is, for example, a camera (see FIG. 2) that is provided at a front portion of the HMD 2 and captures an image of a motion of a hand of the user M.

FIG. 4 is a block diagram illustrating an exemplary configuration of the image generator 1, in accordance with an embodiment of the present disclosure. The image generator 1 includes a controller 10. The controller 10 includes a virtual space constructor 11, a position and attitude calculator 12, an image generator 13, an operation detector 14, a movable range adjuster 15, and a target value determinator 16.

The controller 10 is a computer including a CPU, a RAM, a ROM, a nonvolatile memory, an input/output interface, and the like. The controller 10 may include a GPU for executing three-dimensional (3D) image processing at high speed. The controller 10 may be realized by an arithmetic processing unit or processing circuitry such as a personal computer or a dedicated electronic circuit. In one embodiment, controller 20 of the HMD 2 and the controller 10 of the image generator 1 act as a processing circuitry of the AR vessel maneuvering system 100.

In the controller 10, the CPU functions as a virtual space constructor 11, a position and attitude calculator 12, an image generator 13, an operation detector 14, a movable range adjuster 15, and a target value determinator 16 by executing information processing in accordance with a program loaded from the ROM or the nonvolatile memory to the RAM.

The program may be supplied via an information storage medium such as an optical disk or a memory card, or may be supplied via a communication network such as the Internet.

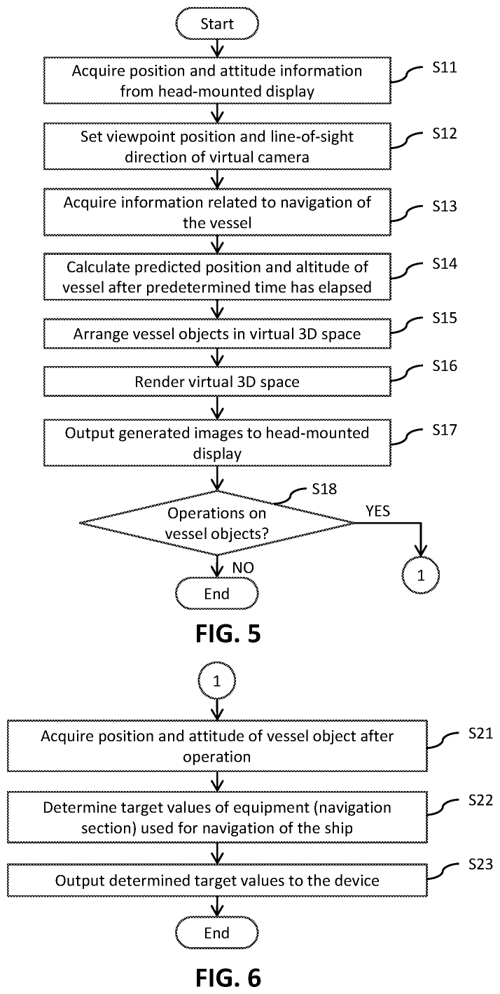

FIGS. 5 and 6 are flow charts illustrating an exemplary procedure of an AR vessel maneuvering method, in accordance with an embodiment of the present disclosure. The AR vessel maneuvering method is realized by the controller 10 of the image generator 1. The controller 10 functions as a virtual space constructor 11, a position and attitude calculator 12, an image generator 13, an operation detector 14, a movable range adjuster 15, and a target value determinator 16 by executing the processes illustrated in these drawings in accordance with a program.

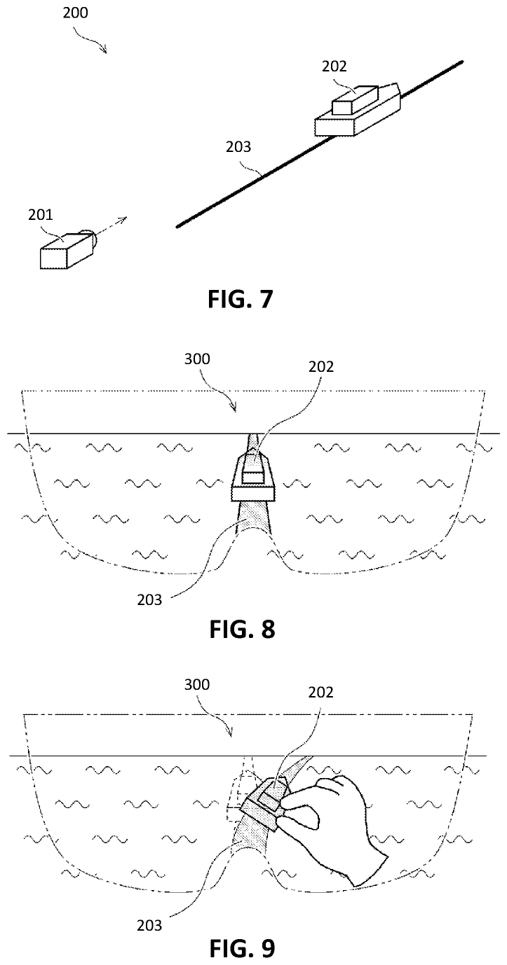

FIG. 7 is a diagram illustrating an example of a virtual three-dimensional (3D) space 200, in accordance with an embodiment of the present disclosure. The virtual 3D space 200 is constructed by the virtual space constructor 11 of the controller 10. A coordinate system of the virtual 3D space 200 corresponds to the coordinate system of the real three-dimensional space.

FIGS. 8 to 11 are diagrams illustrating examples of an image 300 generated by the image generator 13 of the controller 10 and displayed on the HMD 2, in accordance with an embodiment of the present disclosure. In these figures, a field of view of the user M is represented. That is, both the outside scene visually recognized by the user M and the image 300 are shown.

As illustrated in FIG. 5, first, the controller 10 acquires the position information and the attitude information from the HMD 2 (S11) and sets the viewpoint position and the line-of-sight direction of the virtual camera 201 in the virtual 3D space 200 according to the position and the attitude of the HMD 2 (S12; Processing as the virtual space constructor 11).

Specifically, the controller 10 changes the viewpoint position of a virtual camera 201 in the virtual three-dimensional space 200 in accordance with the change in the position of the HMD 2, and changes the line-of-sight direction of the virtual camera 201 in the virtual three-dimensional space 200 in accordance with the change in the attitude of the HMD 2.

Next, the controller 10 acquires information associated with navigation of the vessel (S13), and determines a predicted position and a predicted attitude of the vessel after a predetermined time has elapsed based on the acquired information associated with the navigation of the vessel (S14; Processing as the position and attitude calculator 12). In one embodiment, the determination of the predicted attitude of the vessel may be omitted.

The determination of the predicted position and the predicted attitude of the vessel after the elapse of the predetermined time is performed based on the information associated with the navigation of the vessel acquired from at least one of the plotter 5, the navigation instrument 6, the automatic steering device 7, and the heading sensor 8 (see FIG. 1)

For example, the predicted position and the predicted attitude of the vessel after a predetermined time elapses are determined based on information indicating the navigation state of the vessel such as the vessel speed and the tidal current acquired from the speedometer and the tidal current meter of the navigation instrument 6, the steering angle acquired from the automatic steering device 7, and the heading acquired from the heading sensor 8.

Further, the predicted position and the predicted attitude of the vessel after a predetermined time elapses may be determined based on the navigation information of the vessel such as the target route and the waypoint acquired from the plotter 5.

The predetermined time is appropriately set. For example, it is preferable that the controller 10 determines the predicted position and the predicted attitude after a relatively long time (for example, 10 minutes) when the vessel sails in the open sea, and the controller 10 determines the predicted position and the predicted attitude after a relatively short time (for example, 1 minute) when the vessel sails in the port area (particularly, at the time of docking).

Next, the controller 10 arranges a vessel object 202 representing the vessel in the virtual three-dimensional space 200 based on the determined predicted position and the determined predicted attitude of the vessel after the predetermined time has elapsed (S15; Processing as the virtual space constructor 11).

The vessel object 202 is arranged at a position corresponding to the predicted position in the virtual three-dimensional space 200 in an attitude corresponding to the predicted attitude. The vessel object 202 has a three-dimensional shape imitating a vessel, and the direction of the bow and the stern can be grasped at a glance.

In the example of FIG. 7, the vessel object 202 is disposed ahead of the visual line direction of the virtual camera 201, and the bow is directed in the same direction as the visual line direction of the virtual camera 201, that is, in a direction away from the virtual camera 201.

In the virtual three-dimensional space 200, a route object 203 representing a route on which the vessel travels is arranged. For example, the route object 203 may sequentially connect a plurality of predicted positions calculated for each elapse of a unit time, or may linearly connect the virtual camera 201 and the vessel object 202.

The route object 203 may be generated based on the target route, the waypoint, or the like acquired from the plotter 5 (see FIG. 1).

Next, the controller 10 generates the image 300 by rendering the vessel object 202 and the like arranged in the virtual three-dimensional space 200 based on the visual field of the virtual camera 201 (S16; Processing as the image generator 13) and outputs the generated image 300 to the HMD 2 (S17).

The image 300 generated in this manner has an area corresponding to the viewpoint position and the line-of-sight direction of the HMD 2 (or the virtual camera 201), and includes the vessel object 202 at a position corresponding to the predicted position.

As illustrated in FIG. 8, the image 300 displayed on the HMD 2 includes a vessel object 202 and a route object 203. As a result, the vessel object 202 and the route object 203 are superimposed on the outside scene visually recognized by the user M.

In the image 300, a portion other than the vessel object 202 and the route object 203 is transparent, and only the outside scene is visually recognized by the user M.

According to the present embodiment, the vessel object 202 is included in the image 300 displayed on the HMD 2 at the position corresponding to the predicted position of the vessel after the elapse of the predetermined time in the attitude corresponding to the predicted attitude. Therefore, it is easy to intuitively grasp the future position and attitude of the vessel.

Next, based on the gesture information acquired from the HMD 2, the controller 10 determines whether or not there is an operation on the (marine) vessel object 202 (S18; Processing as the operation detector 14).

Specifically, the gesture information is moving image information of a motion of the hand of the user M captured by the gesture sensor 25 (see FIGS. 2 and 3), and the controller 10 detects an operation associated with a predetermined pattern when the motion of the hand of the user M matches the predetermined pattern.

For example, when there is a tap action by the index finger of the user M, selection of the vessel object 202 is detected. In addition, when there is a pinching action by the index finger and the thumb of the user M, a change in the position or a change in the attitude of the vessel object 202 is detected.

As illustrated in FIG. 9, when the hand of the user M performs a predetermined operation such as a pinching operation at a position corresponding to the vessel object 202, the position and the attitude of the vessel object 202 may be changed.

The operation on the vessel object 202 is not limited to the gesture sensor 25, and may be detected, for example, by coordinate input from a pointing device or by voice input from a microphone. The position of the vessel object 202 before the operation may be any position. That is, the vessel object 202 to be operated may be displayed at a position corresponding to the predicted position described above, or may be the vessel object 202 displayed at an arbitrary position.

When there is an operation on the marine vessel object 202 (YES at S18), the controller 10 acquires the position and the attitude of the vessel object 202 after the operation (S21 in FIG. 6; Processing as the virtual space constructor 11). In one embodiment, the acquisition of the attitude may be omitted.

Next, the controller 10 determines a target value of a device (marine navigation device) used for navigating the vessel based on the acquired position and the acquired attitude of the vessel object 202 (S22; Processing as the target value determinator 16) and outputs the determined target value to the navigation device (S23).

The device used for navigation of the vessel uses the target value received from the image generator 1 as a new target value, and executes a predetermined operation (e.g., a navigation operation) to realize the new target value. Accordingly, the position and the attitude of the vessel object 202 after the operation in the virtual three-dimensional space 200 are reflected in the position and the attitude of the vessel in the real three-dimensional space.

The devices used for navigation of the vessel are the plotter 5, the automatic steering device 7, the engine controller 9, and the like (see FIG. 1), and in S22, target values of at least one of these devices are determined.

The target value for the automatic steering device 7 is, for example, at least one of a target heading and a target steering angle. That is, a target heading or a target steering angle for the vessel to move toward the position of the vessel object 202 after the operation and to take the same attitude is determined. The automatic steering device 7 performs feedback control of the steering device to realize the received target heading or the received target steering angle.

For example, when the vessel object 202 moves rightward from the original position or turns rightward, a target heading or a target steering angle for turning the bow rightward is determined, and when the vessel object 202 moves leftward from the original position or turns leftward, a target heading or a target steering angle for turning the bow leftward is determined.

The target value for the engine controller 9 is, for example, at least one of a target output power and a target speed. That is, the target output power or the target speed for the vessel to reach the position of the vessel object 202 after the operation after the predetermined time elapses is determined. The engine controller 9 performs feedback control of the engine to realize the received target output power or the received target speed.

For example, when the vessel object 202 moves forward from the original position, a higher target output power or a higher target speed than before is determined, and when the vessel object 202 moves backward from the original position, a lower target output power or a lower target speed than before is determined.

The target value for the plotter 5 is, for example, to update the target route. For example, a waypoint may be added to the target route so that the vessel passes through the position of the vessel object 202 after the operation, or the destination of the target route may be changed so that the vessel arrives at the position. The plotter 5 provides the target azimuth based on the updated target route to the automatic steering device 7.

According to the present embodiment, when the user M operates the marine vessel object 202 representing the future position and attitude of the marine vessel, the marine vessel operates to realize the position and attitude of the marine vessel object 202 after the operation. Therefore, it is possible to provide an intuitive operation of the marine vessel. In particular, since a vessel is difficult to move as intended compared to a vehicle or the like, an intuitive operation of designating the future position and attitude of such a vessel is useful.

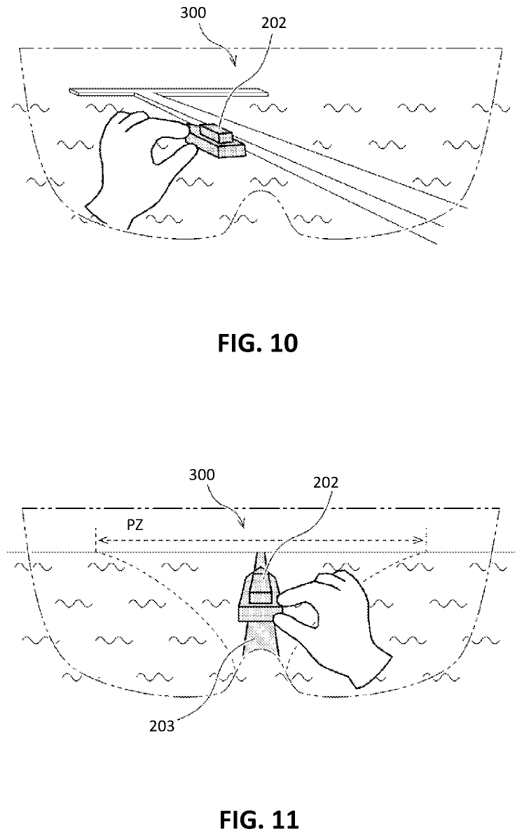

Such an operation may also facilitate docking of the vessel to a pier. For example, as shown in FIG. 10, when the user arranges the marine vessel object 202 at a desired position on the pier in a desired attitude, the automatic steering device 7 and the engine controller 9 execute feedback control to realize the arrangement. Therefore, it is possible to dock the marine vessel at a desired position on the pier in a desired attitude.

When an operation on the vessel object 202 is received at S18, the controller 10 sets a movable range of the vessel object 202 (processing as the movable range adjuster 15).

As shown in FIG. 11, a movable range PZ is set around the vessel object 202, and the movement operation of the vessel object 202 within the movable range PZ is allowed/accepted, and the movement operation of the vessel object 202 to the outside of the movable range PZ is not allowed/accepted.

The movable range PZ is, for example, a turning rate (ROT: Rate of Turn) or a size of the vessel. The information related to characteristics of the vessel is held in advance, for example, in the memory of the controller 10.

The movable range PZ may be set based on information of a navigation region such as a water depth or a navigation prohibited area. The information of the navigation region may be extracted, for example, from chart information held by the plotter 5.

Although the embodiments of the present disclosure have been described above, the present disclosure is not limited to the embodiments described above, and it goes without saying that various modifications can be made by those skilled in the art.

In the above embodiment, the image generator 1 and the HMD 2 are provided separately (see FIG. 1), but the present disclosure is not limited thereto, and the functions of the image generator 1 may be incorporated in the HMD 2. That is, the virtual space constructor 11, the position and attitude calculator 12, the image generator 13, the operation detector 14, the movable range adjuster 15, and the target value determinator 16 (see FIG. 4) may be implemented in the controller 20 (see FIG. 3) of the HMD 2.

In the above embodiment, the image 300 is generated by rendering the vessel object 202 arranged in the virtual three-dimensional space 200 based on the visual field of the virtual camera 201 (see FIGS. 7 and 8). However, rendering of the virtual three-dimensional space is not essential, and two-dimensional image processing may be performed in which the size of the image element of the vessel object is changed according to the distance and included in the image 300.

In the above-described embodiment, the feedback control for realizing the target value determined based on the position and the attitude of the marine vessel object 202 after the operation is executed, but the present disclosure is not limited thereto. For example, the rudder angle may be changed according to the amount of movement of the marine vessel object 202 to the left and right (that is, the role equivalent to the rudder wheels), or the engine output power may be changed according to the amount of movement of the marine vessel object 202 to the front and rear (that is, the role equivalent to the throttle lever).

In the above-described embodiment, the vessel object 202 is superimposed on the outside scene visually recognized by the user by displaying the image 300 on the HMD 2 which is a transmissive head mounted display (see FIG. 8 and the like). However, the present disclosure is not limited thereto, and a composite image obtained by combining the vessel object 202 with an outboard image obtained by capturing an outboard state by a camera, that is, a so-called AR (Augmented Reality) image may be displayed on a thin display such as a liquid crystal display. In this case, the composite image has a region corresponding to the viewpoint position and the line-of-sight direction of the camera.

Although the embodiments of the present disclosure have been described above, the present disclosure is not limited to the embodiments described above, and various modifications can be made by those skilled in the art.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. An augmented reality (AR) vessel maneuvering system, comprising:
processing circuitry configured to:
generate an image including a vessel object representing a vessel in a region corresponding to a viewpoint position and a line-of-sight direction;
superimpose and display an image including the vessel object on an outside scene of a region corresponding to the viewpoint position and the line-of-sight direction;
detect an operation on the vessel object displayed in the image.

2. The AR vessel maneuvering system of claim 1, wherein the processing circuitry is further configured to:
output a command to a navigation device used for navigating the vessel to execute a navigation operation corresponding to the operation on the vessel object.

3. The AR vessel maneuvering system of claim 2, wherein the processing circuitry is further configured to:
determine a target value for the navigation device based on at least one of: a position and an attitude of the vessel object after the operation.

4. The AR vessel maneuvering system of claim 2, wherein:
the navigation device is a marine navigation device.

5. The AR vessel maneuvering system of claim 3, wherein:
the navigation device is an automatic steering device implemented on the vessel, and the target value is one of a target heading and a target steering angle associated with the automatic steering device.

6. The AR vessel maneuvering system of claim 3, wherein:
the navigation device is an engine control device implemented on the vessel, and the target value is one of a target output power and a target speed for the engine control device.

7. The AR vessel maneuvering system of claim 3, wherein:
the navigation device is a plotter implemented on the vessel, and
the target value is one of a target route and a waypoint for the plotter.

8. The AR vessel maneuvering system of claim 1, wherein the processing circuitry is further configured to:
set a movable range of the vessel object based on at least one of: characteristics and navigation region information of the vessel object.

9. The AR vessel maneuvering system of claim 1, wherein the processing circuitry is further configured to:
acquire information associated with navigation of the vessel;
determine a predicted position of the vessel after a predetermined time has elapsed based on the information associated with the navigation of the vessel; and
generate an image including a vessel object representing the vessel at a position corresponding to the predicted position.

10. The AR vessel maneuvering system of claim 9, wherein:
the information associated with the navigation of the vessel is information indicating at least one of: a vessel speed, a steering angle, and a heading of the vessel.

11. The AR vessel maneuvering system of claim 9, wherein:
the information associated with the navigation of the vessel is at least one of: a target route and a waypoint of the vessel.

12. The AR vessel maneuvering system of claim 1, wherein:
the image is displayed on a head-mounted display; and
the processing circuitry is further configured to:
set a viewpoint position and a line-of-sight direction according to a position and an attitude of the head-mounted display; and
generate an image including the vessel object by rendering the vessel object arranged at a position corresponding to a virtual three-dimensional space.

13. An augmented reality (AR) vessel maneuvering method, comprising:
generating an image including a vessel object representing a vessel in a region corresponding to a viewpoint position and a line-of-sight direction;
superimposing and displaying an image including the vessel object on an outside scene of a region corresponding to the viewpoint position and the line-of-sight direction;
detecting an operation on the vessel object displayed in the image.

14. A non-transitory computer-readable storage medium having stored thereon machine-readable instructions that, when executed by one or more processors of an apparatus, cause the apparatus to perform a method comprising:
generating an image including a vessel object representing a vessel in a region corresponding to a viewpoint position and a line-of-sight direction;
superimposing and displaying an image including the vessel object on an outside scene of a region corresponding to the viewpoint position and the line-of-sight direction;
detecting an operation on the vessel object displayed in the image.
